(19) United States
(12) Patent Application Publication
(10) Pub. No.: US 2005/0224474 A1
(43) Pub. Date: Oct. 13, 2005

(54) Method and apparatus for removing a thermal barrier coating from a power generation component

(76) Inventor: Chris A. Kilburn, Buskirk, NY (US)

Correspondence Address: Hoffman, Warnick & D'Alessandro LLC, Three E-Comm Square, Albany, NY, 12207, US

(21) Appl. No.: 11/107,277

(22) Filed: Apr. 15, 2005

Related U.S. Application Data
(63) Continuation-in-part of application No. 10/883,198, filed on Jul. 1, 2004.
Application No. 10/883,198 is a continuation-in-part of application No. 10/273,043, filed on Oct. 17, 2002, now Pat. No. 6,759,627.

(51) Int. Cl. B23K 26/36

(52) U.S. Cl. 219/121.68; 219/121.83

(57) ABSTRACT

The present invention provides a cleaning system and method that utilizes a portable workhead to direct a pulsed laser beam to a surface of a generator, turbine or boiler component or similar surface requiring cleaning and/or removal of a thermal barrier coating (TBC). In a first aspect, the invention provides a laser-based cleaning system for removing a thermal barrier coating from a power generation component, comprising a laser positioned remotely from the power generation component for generating a laser signal, a laser workhead capable of being positioned proximate the power generation component, wherein the laser workhead can deliver a laser beam onto the power generation component surface to cause the thermal barrier coating to be removed, and a light guide that delivers the laser signal from the laser to the laser workhead.

### CROSS REFERENCE TO RELATED APPLICATIONS

This is a continuation-in-part application of prior co-pending U.S. patent application Ser. No. 10/883,198, filed Jul. 1, 2004, which is a continuation-in-part application of U.S. patent application Ser. No. 10/273,043, filed Oct. 17, 2002, now U.S. Pat. No. 6,759,627.

### BACKGROUND OF THE INVENTION

1. Technical Field

The present invention relates to cleaning systems, and more particularly relates to a laser-based ablation system and method for use thereof.

2. Related Art

Maintaining and cleaning large-scale turbine, generator, and boiler components (referred to collectively as “power generation components”) such as those found in power generation plants and jet engines, represent a significant operational cost. The combination of intense stresses placed on the components and contaminants introduced into the components requires that such large-scale systems follow a strict maintenance and inspection schedule. Unfortunately, this results in these machines being taken “off-line” for a period of time for servicing. Every hour of downtime results in significant lost revenue, particularly in power generation plants and the like.

Similarly, the thermal barrier coatings (TBCs) commonly applied to the surfaces of gas turbine components require periodic removal. Accordingly, the need for quick and efficient, waste-reducing cleaning and analysis techniques for turbine and generator components remains an ongoing challenge.

Cleaning generator, turbine, or boiler components may, for instance, require a complete disassembly, e.g., removal of the turbine from its housing, removal of the rotating field from the stator core, etc. The process of completely disassembling such a machine is a complex and expensive process. In the past, effectively cleaning certain components without a complete disassembly was almost impossible given that a foreign material (e.g., blast media) would need to be introduced, therefore potentially contaminating other parts of the machine.

Exemplary components requiring cleaning include turbine blades, the generator stator core, rotating field coils, rotor forging, retaining rings, condenser tubes, boiler tubes, etc. Cleaning may include removing dust, oily deposits, combustion deposits and other surface contamination, as well as TBCs applied for protective purposes. For example, turbine parts, such as turbine blades, may require the removal of built up debris that is reducing the overall efficiency of the machine, or impeding inspection. Past methods for cleaning such parts typically included a high-pressure application of aluminum oxide, glass bead, or CO₂.

Cleaning generator parts often involves removal of residual insulation and resins from the coil slots in the rotor forging and stator core when the windings are removed for a rewind. The current methods of cleaning such components are essentially manual, e.g., using scrapers made of TEXTOLITE™, wiping with rags soaked in approved cleaning solutions, and polishing with a clean, dry rag. Likewise, if the rotor coils are to be reused, removal of insulation and resins from the coils is also required. Rotor forging and rotor coils to be reused are often cleaned by blasting with glass beads. Rotor coils wrapped with glass mica tape can also be cleaned by heating in an oven to burn off the tape and subsequently cleaned with approved solvents and rags.

The above-described methods are not only labor intensive, but also pose an environmental hazard. For example, the process of removing and disposing of the used glass beads and corncob, as well as processes related to collecting and disposing of the contaminated rags after cleaning create environmental waste. Workmen are exposed to hazardous chemical cleaners and are subjected to potential exposure to airborne contamination of the media used for blast cleaning. The blast cleaning media can escape from the enclosure and contaminate the surrounding area. In addition, such blast cleaning may release asbestos particles, a common component of insulation in turbine windings and stator bars. Accordingly, there exists a need to overcome the problems faced by prior approaches.

### SUMMARY OF THE INVENTION

The present invention addresses the above-mentioned problems, as well as others, by providing a cleaning system and method that utilizes a portable workhead to direct a pulsed laser beam to a surface of a generator, turbine or boiler component or similar surface requiring cleaning and/or removal of a TBC. In a first aspect, the invention provides a laser-based cleaning system for removing a thermal barrier coating from a power generation component, comprising a laser positioned remotely from the power generation component for generating a laser signal, a laser workhead capable of being positioned proximate the power generation component, wherein the laser workhead can deliver a laser beam onto the power generation component surface to cause the thermal barrier coating to be removed, and a light guide that delivers the laser signal from the laser to the laser workhead.

In a second aspect, the invention provides a method for laser-based removal of a thermal barrier coating from components in a gas turbine, comprising positioning a laser remotely from the turbine, steering a flexible member through an opening leading to a component in a turbine housing, providing within the flexible member a laser workhead that receives a laser signal from the laser via a light guide, remotely positioning the workhead proximate a turbine component such that the workhead can deliver a laser beam onto a surface of the turbine component, and remotely moving the workhead along the turbine component while the laser beam ablates the surface of the turbine component to effectuate a removal of the thermal barrier coating.

In a third aspect, the invention provides a laser-based analysis system for analyzing material removed from a surface of a power generation component, comprising a laser positioned remotely from the power generation component for generating a laser signal, a laser workhead that is capable of being positioned proximate the power generation component, wherein the laser workhead can deliver a laser beam onto the power generation component surface to cause a removal of a material, a light guide that delivers the laser signal from the laser to the laser workhead, and a spectrometer for analyzing at least one of a plasma, a vapor, a gas, and a solid produced by the removal of the material on the power generation component surface.

In a fourth aspect, the invention provides a method of reducing the radioactivity of a surface comprising positioning a laser remotely from the surface, providing a laser workhead that receives a laser signal from the laser via a light guide, positioning the workhead proximate the surface such that the workhead can deliver a laser beam onto the surface, and moving the workhead along the surface while the laser beam ablates the surface to effectuate a reduction in the radioactivity of the surface.

In a fifth aspect, the invention provides a laser-based cleaning system for cleaning a power generation component, comprising a laser positioned remotely from the power generation component for generating a laser signal, a robotic device capable of being maneuvered into an enclosure containing the power generation component, a laser workhead attached to the robotic device that is capable of being positioned proximate the power generation component, wherein the laser workhead can deliver a laser beam onto the power generation component surface to cause a cleaning, and a light guide that delivers the laser signal from the laser to the laser workhead.

### BRIEF DESCRIPTION OF THE DRAWINGS

The embodiments of this invention will be described in detail, with reference to the following figures, wherein like designations denote like elements, and wherein:

FIG. 1 shows an exemplary turbine system seated in the bottom portion of a turbine housing.

FIG. 2 shows an embodiment of an exemplary cleaning system for cleaning turbine parts

FIG. 3 shows a cross-sectional view of a set of turbine blades being cleaned using a cleaning system of the present invention.

FIG. 4 shows a cross-sectional view of a set of turbine blades being cleaned using an another embodiment of a cleaning system of the present invention.

FIG. 5 shows a cross-sectional view of a rotor bore being cleaned using a robotically-controlled cleaning system of the present invention.

FIG. 6 shows a diagrammatic representation of a laser cleaning system of the present invention.

FIG. 7 shows a partial cutaway view of turbine being cleaned using a cleaning system of the present invention, wherein a flexible member of the cleaning system passes through a steam supply line.

FIG. 8 shows a partial cutaway view of a condenser tube being cleaned using a cleaning system of the present invention.

FIG. 9 shows a cross-sectional view of an exemplary thermal barrier coating capable of being removed using a cleaning system of the present invention.

### DETAILED DESCRIPTION OF THE INVENTION

Overview

The present invention provides various laser-based systems and methods for cleaning boiler, generator, and turbine parts (collectively “power generation components”) or other surfaces requiring cleaning and/or removal of a thermal barrier coating (TBC). As noted above, cleaning such components is critical for maintaining performance, and is also a prerequisite for performing non-destructive evaluations (NDEs). It should be understood that the invention could be applied to any type of mechanical power system, e.g., boilers, gas turbines, steam turbines, jet engines, compressors, etc., that utilizes parts which require cleaning.

Turbine Blades

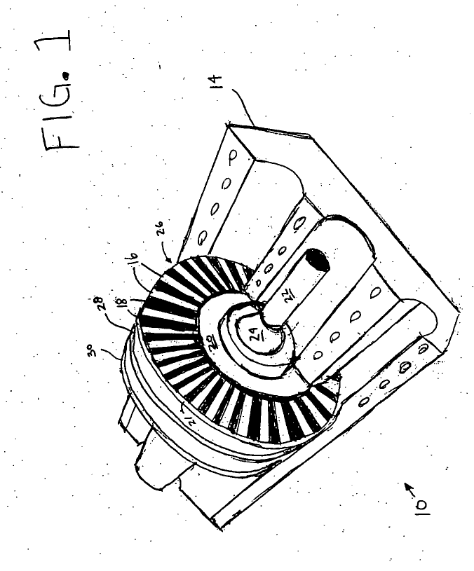

Referring now the drawings, FIG. 1 depicts an exemplary turbine system 10 seated in the bottom portion of a turbine housing 14. The turbine system 10 would typically sit on a turbine deck (not shown). The top portion of the housing (not shown) has been removed to expose the inner workings of the turbine system 10. The depicted turbine comprises a multistage turbine having three turbine units or turbine rotor assemblies 26, 28 and 30 mounted to a hub 24 on a shaft 22. Each assembly 26, 28, 30 comprises a plurality of radial extending blades 16 separated by a spacing 18. Depending on the particular specification, the configuration, spacing, pitch, etc., of the blades will vary. Each blade 16 is attached at a dovetail section 20 to the main shaft 22.

The ability to regularly clean the turbine blades 16 and dovetail section 20 has been shown to greatly improve performance of the turbine. Tests have shown that a 3-5 mil build-up of debris on the turbine blades will reduce the efficiency of the turbine 3-4%. Moreover, cleaning is also required before a non-destructive evaluation (NDE) can be performed (e.g., checking for failures, measuring tolerances, etc.). Prior to this invention, however, cleaning the turbine blades and dovetail section 20 required the entire turbine to be removed from its housing 14 to a clean-room environment, where the parts could be blasted with a foreign media. Such a disassembly resulted in extended downtime for the unit, which significantly drove up the costs of the cleaning process. Moreover, because prior cleaning techniques required the introduction of a blast media, it was not possible to clean the turbine in its housing.

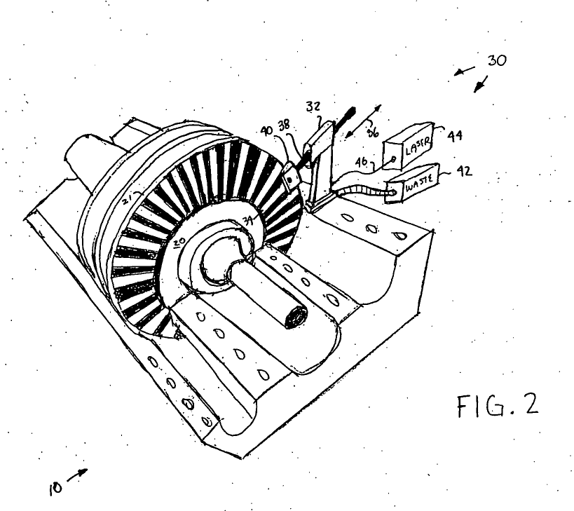

FIG. 2 depicts an embodiment of an exemplary cleaning system 30 for cleaning turbine parts, without the need of removing the turbine from lower housing 14. The cleaning system 30 includes a robot 32 for manipulating a laser workhead (not shown) capable of laser ablating debris from various turbine parts. In this exemplary embodiment, robot 32 comprises an arm 38 that moves a robotic work unit 40 along a turbine blade 34 in a generally radial motion 36. The robotic work unit 40 moves the laser workhead to various positions along the turbine blade using known robotic techniques. The laser workhead delivers a pulsed laser beam onto the surface of the blade using a pre-programmed pattern, ablating the surface and evenly removing built up debris. Any loose debris resulting from the ablation process is removed by a vacuum system, contained in the robotic workhead 40, to a remote waste container 42, thereby avoiding the possibility of contamination in the turbine system 10.

A remotely located laser 44 transmits a laser beam over a light guide 46 to the laser workhead thereby allowing a relatively small and versatile workhead to be used to remove debris from the turbine blades and related parts. As is described in more detail below, laser 44 may comprise any type of laser system (e.g., a YAG laser or a CO₂ laser) capable of delivering a relatively high power laser beam (e.g., 0.5-5 kilowatts) through a light guide. Suitable light guides include, for example, those available from OmniGuide Communications (http://www.omni-guide.com) and described by Dellemann et al. (“Perfect Mirrors Extend Hollow-Core Fiber Applications,” available at http://www.omni-guide.com /Pages /TechPapers /OmniFeature.pdf). Traditional fiber optic devices known in the art are likewise suitable for use in the claimed invention.

In addition, robotic workhead 40 may also include a non-destructive evaluation (NDE) system for examining the turbine component for cracks or other failures after it is cleaned. Known NDE techniques are presently utilized for the inspection of steam and gas turbine blades with an emphasis on detecting minute defects in the blades. High inspection sensitivity is obtained, for instance, by using video cameras along with specialized magnetic particle and eddy current inspection methods. Accordingly, the laser workhead of the present invention could be retrofitted to an existing NDE system, or vice versa. An exemplary NDE system is described in U.S. Pat. No. 5,189,915, SINGLE MODE ULTRASONIC INSPECTION METHOD AND APPARATUS, assigned to Reinhart & Associates, Inc., of Austin Tex., which is hereby incorporated by reference. Other exemplary systems are provided by the assignee and are described at their website at http://reinhartassoc.com.

In the exemplary embodiment shown, cleaning system 30 is mounted to a side portion of lower housing 14. However, it should be recognized that cleaning system 14 could be mounted anywhere relative to turbine system 10, (e.g., on the shaft, on the turbine rotor assembly itself, on the turbine deck, on a separate standalone device, etc.). Furthermore, the blades could be cleaned with a portable handheld unit, as opposed to robotics. After a set of blades is cleaned, the turbine rotor assembly can be rotated into position for a next set of blades, and so on, until all of the blades have been cleaned. The robotics necessary to carry out the cleaning operation could be implemented in any manner, and any such variations are believed to fall within the scope of the present invention. For example, the cleaning system 30 could be adapted to clean multiple blades and/or clean both sides of the blade during one pass. Furthermore, the cleaning system 30 could be adapted to clean the dovetail section 20, as well the outer ring 21.

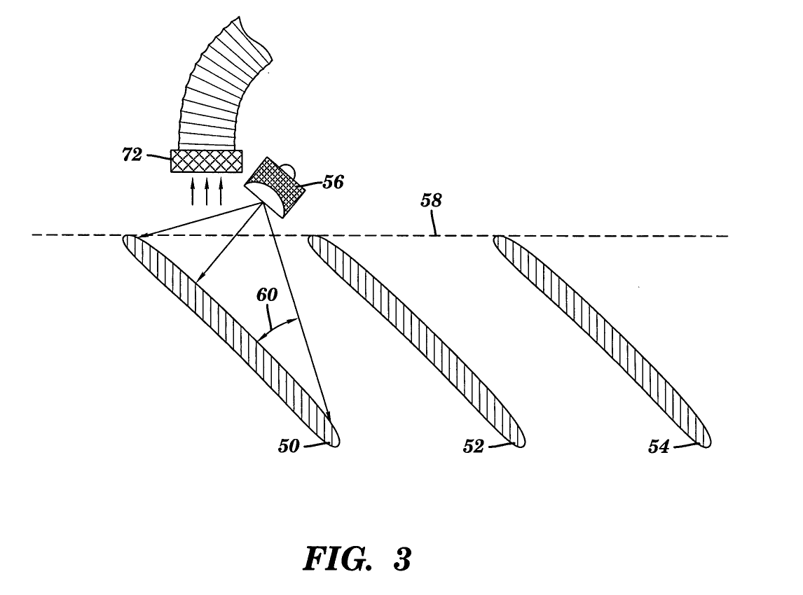

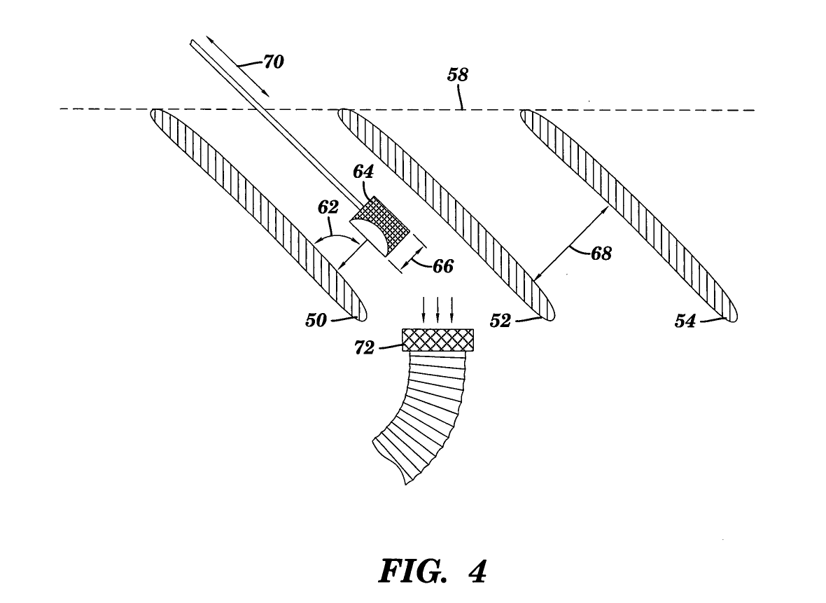

Referring now to FIGS. 3 and 4, a cutaway view looking down into a set of turbine blades 50, 52, 54 is shown. As can be seen, the blades are pitched such that they will be driven in a leftward or rightward direction when a fluid flow is passed therethough. The blade pitch may create an overlap among the blades, which adds complexity to the laser ablation operation. In the embodiment of FIG. 3, a laser workhead 56 is shown that operates externally (shown by dashed line 58) to the turbine rotor assembly. This embodiment assumes a “line of sight” application in which the entire surface can be cleaned from an externally positioned laser source. This embodiment may also be useful when the spacing between blades makes it impractical to insert a workhead between the blades. Located proximate laser workhead 56 is a vacuum system 72 for removing loose debris. In this embodiment, the laser workhead 56 does not need to enter into the spacing between the blades. Instead, the laser workhead can be angled so that the laser beam can reach the entire blade 50.

However, as the attack angle 60 becomes smaller, the efficacy of the laser ablation decreases. To compensate, the present invention will cause the laser system to either increase power or increase the ablation time in an amount proportional to attack angle 60. For instance, in a relatively straight ablation (i.e., attack angle 52 is 90 degrees +/− some predetermined variance), the present invention proposes a strip rate of a square foot per minute per kilowatt for a 1-2 mil ablation. As the attack angle 60 decreases, the strip rate would decrease proportionally to ensure adequate stripping.

FIG. 4 depicts a second embodiment for cleaning overlapping blades 50, 52, 54. In this case, laser workhead 64 is manipulated along arrow 70 into the spacing within the blades. To achieve this, the laser workhead 64 is designed to have a depth dimension 66 that is less than a minimal blade opening 68. Thus, a relatively perpendicular attack angle 62 can be maintained during the cleaning process. Also shown in FIG. 4 is an alternative vacuum system 72 location. Namely, in this embodiment, the vacuum system 72 is located on the opposite side of the turbine rotor assembly.

Rotor Bore

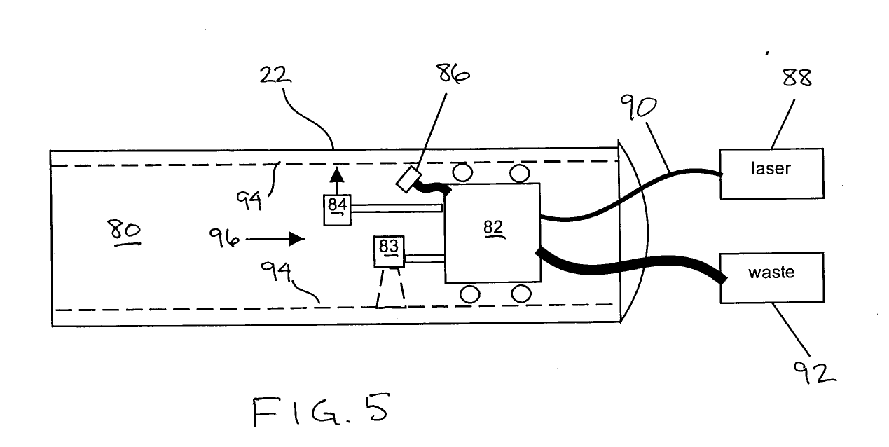

The interior of the shaft 22, referred to as the rotor bore 80 represents another important area of the turbine that requires regular cleaning, as the rotor bore is subject to regular non-destructive examinations. FIG. 5 depicts a cross-sectional view of the rotor bore 80 that includes a circular inner wall 94, which is cleaned with laser ablation by cleaning device 96. Cleaning device 96 comprises a robot 82 that traverses the inside of shaft 22 and transports a laser workhead 84 and vacuum system 86. Robot 82 comprises the necessary functionality to position laser workhead 84 throughout the bore 80, thereby allowing a continuous and uniform cleaning operation.

A laser 88 is positioned outside of the shaft 22, and communicates a laser signal through fiber optics 90. A waste collection system 92 is also positioned outside of the shaft 22 for the collection of debris captured by vacuum system 86. Any type of robot system capable of traversing a bore could be utilized. In addition, the cleaning device 96 may comprise an NDE system 83 that examines the surface after it is cleaned.

In addition to cleaning rotor bores, this configuration can be applied to clean any type of tubular opening, e.g., pipes, condenser cores, boiler tubes, etc.

Generator Parts

In addition to the turbine parts described above, the concepts of the present invention could be applied to other components, including generator parts. For instance, the copper bars that make up the generator windings also require regular cleaning. A robotic device containing a portable laser workhead could be utilized in a similar fashion to laser ablate debris therefrom. Similarly, the stator core could be cleaned using the present system. An NDE system could also be incorporated to inspect the parts after they are cleaned.

Laser System

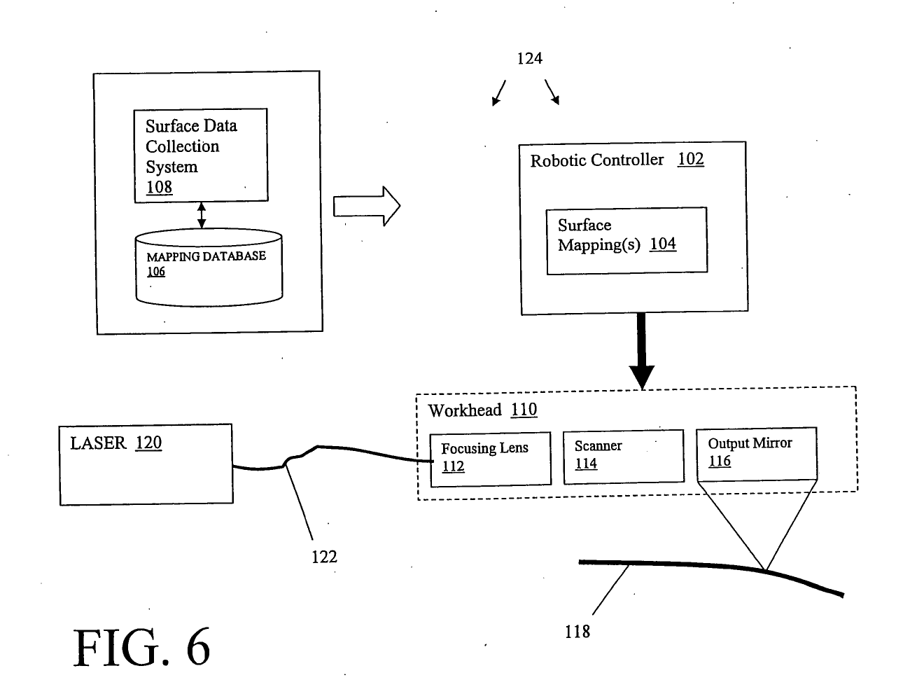

Referring now to FIG. 6, a laser system is shown, which generally comprises a laser 120 remotely connected to a laser workhead 110 via light guide 122. Workhead 110 is designed to laser ablate a predefined surface area on a work piece 118, e.g., a section comprising a one inch diameter circle. After a section is ablated, the process can be repeated on another section either by moving work piece 118 and/or workhead 110 until the entire work piece 118 has been cleaned.

Workhead 110 receives the laser signal from laser 120 and first passes the workhead through a focusing lens 112. Scanner 114 moves the beam to a new position for each pulse until a section is ablated. A typical system will generate pulses at a rate of 10-15 kHz. The beam may be moved in any pattern to ablate a section, e.g., a spiral, back and forth, etc. Output mirror 116 generates the focused beam onto the surface or work piece 118. A typical focused beam will be on the order 0.5 millimeters in diameter for a YAG laser, and as much as 0.5 inches for a CO₂ laser. As noted, after a section has been ablated, the workhead can be repositioned to a new section.

In order to achieve efficient ablation, the present invention proposes a power output of 1-2 kilowatts for laser 120. If necessary, several smaller lasers (e.g., two 600 watt lasers) could be utilized. Laser 120 is preferably an industrial laser capable of pulsed operation, e.g., a CO₂ laser, a Q switched CO₂ laser, a Q switched Nd:YAG (“YAG”), or other YAG laser. U.S. Pat. No. 6,288,362 B1 issued to Thomas et al. on Sep. 11, 2001, entitled METHOD AND APPARATUS FOR TREATING SURFACES AND ABLATING SURFACE MATERIAL, describes such as system, and is hereby incorporated by reference. As noted above, a proposed strip rate for a 1-2 mil thickness ablation is approximately one square foot per minute per kilowatt.

As shown in FIG. 6, workhead 110 may be positioned from section to section by a robotic controller 102. Robotic controller 102, for example, moves workhead 110 along a turbine blade to achieve an automated and uniform ablation. Robotic controller may include a surface mapping 104 of the turbine part being cleaned. Surface mapping 104 defines the position and contours of the work piece being cleaned. Surface mapping 104 may be obtained by a surface data collection system 108, and be stored in mapping database 106. For example, because there exists numerous turbine systems, many different blade configurations and styles exist. Accordingly, a mapping for each different model could be stored in mapping database 106, and then uploaded to robotic controller 102 as needed.

As an alternative, a portable handheld device comprising workhead 110 could be used to clean turbine parts.

Methods Utilizing a Flexible Member and Miniature Robotics

In some situations, it may be impractical to disassemble the turbine, generator, boiler, or other power generator, in order to clean and inspect its components. To address this, in one embodiment, the present invention provides a laser workhead attached to a steerable, flexible member for remotely cleaning parts, e.g., contained in a housing. The flexible member can be remotely steered into locations within the power generator not otherwise accessible without disassembly. The laser workhead connected to a laser via a flexible light guide and optionally may include an NDE system and/or a vacuum system. The flexible member may be embodied in a boroscope or endoscope type device (or similar device having a flexible, manipulable shaft) such as those described by Szewczyk et al. in “An Active Tubular Polyarticulated Micro-System for Flexible Endoscope.” Such a device includes a steering mechanism that can manipulate the flexible member into an interior cavity, canal, tube, vessel, etc., and may include any number of systems to facilitate the process, e.g., light guides, tools, optics, electronics, image transmission systems, etc.

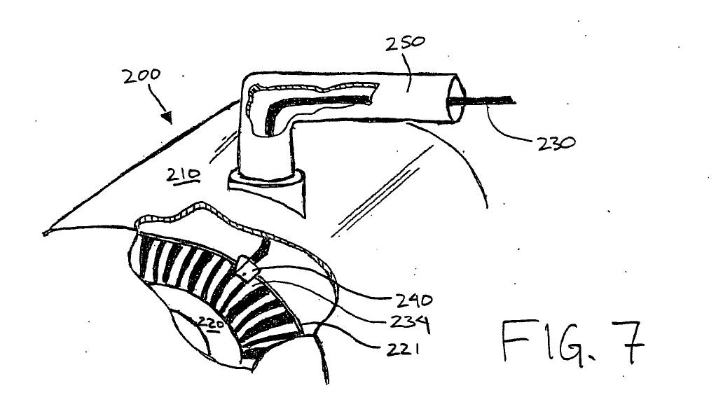

Referring now to FIG. 7, a partial cutaway view of turbine 200 and steam supply line 250 is shown. Using a flexible member 230, the laser system of the claimed invention can be employed to clean turbine blades 234 of a turbine rotary assembly without the need to disassemble turbine housing 210. Workhead 240 is passed through steam supply line 250 by means of flexible member 230 and positioned proximal to turbine blade 234. Workhead 240 could similarly be passed through inspection hand holes (not shown) or similar access points in turbine housing 210, rather than through steam supply line 250. Turbine blade 234 is then cleaned and inspected as described above. Workhead 240 may also be positioned to clean and inspect outer ring 221 and dovetail section 220. Similarly, workhead 240 could be used to clean any tubular power generation component, such as a rotor bore 80 as shown in FIG. 5, or other tubular opening. Such a tubular opening can be of any size or cross-sectional shape through which robotic workhead 240 can be manipulated.

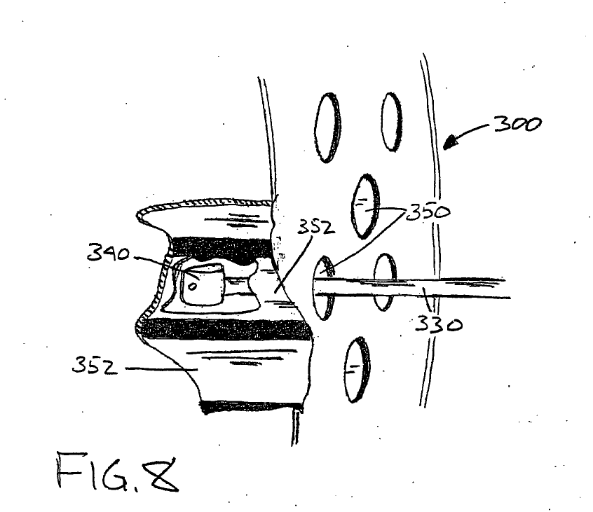

Referring now to FIG. 8, a partial cutaway view of a condenser array 300 and condenser tube 352 is shown. Using a flexible member 330, the laser system of the claimed invention can be employed to clean condenser tubes 352. Robotic workhead 340 is inserted into condenser tube opening 350 and steered along the interior of condenser tube 352 by means of flexible member 330. The interior surface of condenser tube 352 is then cleaned and inspected as described above. The laser system of the claimed invention could similarly be used to clean and/or inspect the interior and exterior surfaces of a boiler tube (not shown) or similar power generation component.

As noted above, the invention may be implemented using a light guide comprising a low-loss waveguide that utilizes omnidirectional mirrors. This technology utilizes a 1-D photonic bandgap fiber to create a perfect mirror in which the fiber guides the light almost exclusively in its hollow core.

Alternatively, a robotic device, particularly a miniature robotic device, may be employed in situations such as those above. Suitable robotic devices include, for example, the Mobile Aerospace Robotic Vehicle (MARV) available from Skywalker Robotics (http://www.skywalkerrobotics.com). Such robotic devices provide additional capabilities not offered by a boroscope or endoscope. For example, such robotic devices are capable of moving along floors, walls, and ceilings, making both inner and outer angled turns to transition from one to another. A laser workhead may be attached to such a robotic device and transported to and along surfaces not otherwise accessible without disassembly of a surrounding structure.

Thermal Barrier Coatings

In some applications, power generation components or other surfaces may include a protective coating. For example, various components of gas turbines, including inlets, compressors, shafts, burners, afterburners, turbines, turbine blades, combustor cans, and nozzles, may be coated with a thermal barrier coating (TBC) to protect the component from damage due to the high temperatures at which they operate.

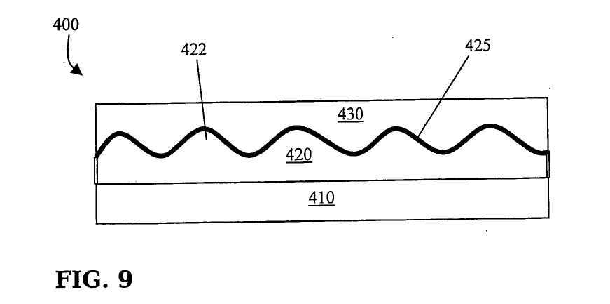

FIG. 9 shows a cross-sectional view of an exemplary TBC 400, comprising several TBC layers 420, 425, 430. Substrate 410 may be any material for which a TBC will provide protection. In gas turbines, for example, substrate 410 is often a nickel superalloy. Bond coat 420 is layered atop substrate 410. Bond coat 420 is often metallic. Exemplary bond coats are of the formula MCrAIX, wherein M is nickel (Ni), cobalt (Co), or iron (Fe), and X is yttrium (Y), zirconium (Zr), hafnium (Hf), or ytterbium (Yb). Thermally grown oxide layer 425 comprises a layer of oxidized aluminum, generally aluminum oxide (Al₂O₃) from bond coat 420. Ceramic insulating layer 430 is a thermal-resistant ceramic. Suitable ceramics include, for example, zirconia (ZrO₂) stabilized with 6-8% yttria (Y₂O₃) available from Reade Advanced Materials (http://www.reade.com). Other TBC layers or combinations of layers are possible, the above description being exemplary and in no way limiting of the invention.

Occasionally, one or more layers of such a TBC must be removed to inspect an underlying component or because the TBC layer has been damaged. More frequently, a TBC will fail in a relatively small area of a protected surface, such as a turbine blade. Such failures create “hot spots” where the surface has inadequate thermal protection and is subject to thermal damage. Most modem gas turbines perform realtime monitoring of the blades to identify such “hot spots.” When a “hot spot” is found, a typical solution is to run the turbine at a lower temperature to avoid both thermal damage at the “hot spot” and the massive failure of the turbine that may result from such thermal damage. However, operating the turbine at a lower temperature decreases its efficiency, often dramatically.

Due to the fact that the TBC is designed to withstand extreme environments and high temperatures, conventional methods of removal, such as with solvents or mechanical means, can be difficult. However, the laser-based cleaning system of the present invention, as described above, has been found effective in such removal by ablating the TBC layers, reducing them to a plasma, a vapor, a gas, or a solid detached from the component surface. In the situation described above, where a “hot spot” has developed on a turbine blade, the removal of one or more combustor cans allows remote access to the hotspot using a laser-based system of the present invention. The area of failed TBC may then be removed by laser ablation and a new coating applied. Such maintenance may be performed using the robotic- or boroscope /endoscope-based systems described above without a complete tear down of the turbine.

Radiological Decontamination

In addition to the removal of contaminants or TBCs, as described above, a laser-based cleaning system according to the present invention may be effectively employed in the decontamination of radiological materials. Such materials may, for example, be the normal and expected result of industrial processes or may be the result of a spill or other unintended release of such materials. It may be necessary, therefore, to eliminate or reduce the radioactivity of such materials in order to reactivate contaminated equipment or spaces or before disposal of radiological wastes or contaminated equipment.

It has been shown, for example, that laser ablation of a radiologically-contaminated surface can significantly reduce the surface's radioactivity. In one test, after four manually-operated laser passes over a contaminated surface, the combined beta and gamma radioactivity of the surface was reduced from 2,000 millirems (mr) per hour to 500 mr/h, with the gamma radioactivity reduced from 600 mr/h to 200 mr/h. Additional laser passes and/or automated control of the laser, such as with the robotic devices described above, would be expected to further reduce the surface's radioactivity. The effect of laser ablation on the level of other forms of radiation is similar.

Such reductions in radioactivity are of great significance in terms of worker safety and the economic impact of such contamination. For example, current regulations limit a worker's annual radiological exposure to 5,000 mr. The ability to significantly reduce the radioactivity of a piece of equipment or an area may permit continued use of the equipment or entry of workers into the area to facilitate further decontamination.

Spectrometer

In some cases, it may be necessary or desirable to analyze the materials to be removed from a power generation component or other surface using the laser-based cleaning system of the present invention. For example, in removing a TBC layer from a gas turbine, it may be necessary or desirable to determine the chemical composition of the layer. Such determination may enable more precise or automated operation of the laser, such as stoppage of the laser upon detection of a particular element or compound or continuing ablation until a particular element or compound is no longer detected. Such operation permits, for example, the selective removal of TBC layers.

Similarly, it may be necessary or desirable to accurately identify the source of contamination or debris adhering to the power generation component. In such situations, the laser-based cleaning system of the present invention may further include a spectrometer for analyzing a plasma, vapor, gas, or solid produced by the laser ablation of materials on a surface of a power generation component. Suitable spectrometers include, for example, the laser-induced breakdown spectrometers available from OceanOptics, Inc. (http://www.oceanoptics.com). Such a spectrometer may be included in the laser-based cleaning system of the present invention in a way similar to the inclusion of a vacuum device, whereby the spectrometer is positioned such that laser-ablated material is drawn into or otherwise introduced to the spectrometer for analysis. In other situations, the primary purpose of the laser-based system of the present invention may be the analysis of surface materials, the laser providing a means for producing a plasma, vapor, gas, or solid that can be analyzed by a spectrometer.

Sensors and Monitors

In some situations, it may also be desirable to include within the laser-based systems of the present invention, one or more sensors or monitors suitable for detecting, analyzing, and /or recording various environmental conditions in which the system is operating. For example, where a system of the present invention is employed to remove radioactive contamination, it may be desirable to include one or more sensors capable of detecting radioisotopes. In other environments, it may similarly be desirable to include sensors capable of detecting chemical or biological agents. Any such sensors known in the art may be so employed. Sensors may be attached directly to the laser workhead or, where a robotic device is included in the system, to the robotic device.

In addition, it may be desirable to employ video monitoring or recording devices in the operation of the systems of the present invention. In many applications, it may be difficult or impossible to manipulate the laser workhead into position without the ability to determine its desired path. A video camera, as known in the art, may therefore be attached to the laser workhead or a robotic device to which the workhead is attached. Such devices are also helpful in assessing the progress of the laser ablation, enabling a user to perform additional ablation along surfaces requiring additional cleaning or to suspend ablation along surfaces that either require no additional cleaning or which may be damaged by additional ablation.

The foregoing description of the preferred embodiments of the invention has been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

1. A laser-based cleaning system for removing a thermal barrier coating from a power generation component, comprising:
a laser positioned remotely from the power generation component for generating a laser signal;
a laser workhead capable of being positioned proximate the power generation component, wherein the laser workhead can deliver a laser beam onto the power generation component surface to cause the thermal barrier coating to be removed; and
a light guide that delivers the laser signal from the laser to the laser workhead.

2. The laser-based cleaning system of claim 1, wherein the thermal barrier coating includes zirconia.

3. The laser-based cleaning system of claim 2, wherein the zirconia is stabilized with about 6% to about 8% yttria, by weight.

4. The laser-based cleaning system of claim 1, wherein the laser selected from a group consisting of a “YAG” laser and a CO₂ laser.

5. The laser-based cleaning system of claim 1, further comprising a vacuum.

6. The laser-based cleaning system of claim 1, wherein the workhead includes a non-destructive evaluation system for examining the power generation component during a removing operation.

7. The laser-based cleaning system of claim 1, further comprising a member having a flexible, manipulable shaft that can be remotely steered into an enclosure containing the power generation component.

8. The laser-based cleaning system of claim 7, wherein the member comprises at least one of a boroscope and an endoscope.

9. The laser-based cleaning system of claim 1, further comprising a robotic device capable of transporting the laser workhead to a location proximate the power generation component surface.

10. The laser-based cleaning system of claim 1, wherein the laser is robotically controlled.

11. The laser-based cleaning system of claim 1, further comprising a spectrometer for analyzing at least one of a plasma, a vapor, a gas, and a solid produced by the delivery of the laser beam onto a surface of the power generation component surface.

12. The laser-based cleaning system of claim 1, further comprising a video monitoring device.

13. The laser-based cleaning system of claim 1, further comprising at least one of a radiological sensor, a chemical sensor, and a biological sensor.

14. A method for laser-based removal of a thermal barrier coating from components in a gas turbine, comprising:
positioning a laser remotely from the turbine;
steering a flexible member through an opening leading to a component in a turbine housing;
providing within the flexible member a laser workhead that receives a laser signal from the laser via a light guide;
remotely positioning the workhead proximate a turbine component such that the workhead can deliver a laser beam onto a surface of the turbine component; and
remotely moving the workhead along the turbine component while the laser beam ablates the surface of the turbine component to effectuate a removal of the thermal barrier coating.

15. The method of claim 14, further comprising the step of vacuuming debris caused by the ablation.

16. The method of claim 14, further comprising the step of analyzing at least one of a plasma, a vapor, a gas, and a solid caused by the ablation using a spectrometer.

17. The method of claim 14, wherein the turbine component is selected from a group consisting of an inlet, a compressor, a shaft, a burner, a turbine, an afterburner, a combustor can, and a nozzle.

18. The method of claim 14, wherein the laser is selected from a group consisting of a “YAG” laser and a CO₂ laser.

19. The method of claim 14, comprising the further step of using the flexible member to perform a non-destructive evaluation of a turbine part.

20. The method of claim 14, wherein the flexible member includes at least one of a boroscope and an endoscope.

21. A laser-based analysis system for analyzing material removed from a surface of a power generation component, comprising:
a laser positioned remotely from the power generation component for generating a laser signal;
a laser workhead that is capable of being positioned proximate the power generation component, wherein the laser workhead can deliver a laser beam onto the power generation component surface to cause a removal of a material;
a light guide that delivers the laser signal from the laser to the laser workhead; and
a spectrometer for analyzing at least one of a plasma, a vapor, a gas, and a solid produced by the removal of the material on the power generation component surface.

22. The laser-based analysis system of claim 21, wherein the laser workhead is attached to a member having a flexible, manipulable shaft that can be remotely steered into an enclosure containing the power generation component.

23. The laser-based analysis system of claim 22, wherein the member comprises at least one of a boroscope and an endoscope.

24. The laser-based analysis system of claim 21, wherein the laser workhead is attached to a robotic device.

25. The laser-based analysis system of claim 21, further comprising a vacuum.

26. The laser-based analysis system of claim 21, wherein the workhead includes a non-destructive evaluation system for examining the power generation component during a analyzing operation.

27. The laser-based analysis system of claim 21, wherein the laser is selected from a group consisting of a “YAG” laser and a CO₂ laser.

28. The laser-based analysis system of claim 21, further comprising at least one of a radiological sensor, a chemical sensor, and a biological sensor.

29. A method of reducing the radioactivity of a surface comprising:
positioning a laser remotely from the surface;
providing a laser workhead that receives a laser signal from the laser via a light guide;
positioning the workhead proximate the surface such that the workhead can deliver a laser beam onto the surface; and
moving the workhead along the surface while the laser beam ablates the surface to effectuate a reduction in the radioactivity of the surface.

30. The method of claim 29, further comprising the step of vacuuming debris caused by the ablation.

31. The method of claim 29, further comprising the step of analyzing at least one of a plasma, a vapor, a gas, and a solid caused by the ablation using a spectrometer.

32. The method of claim 29, further comprising the step of performing a non-destructive evaluation of the surface.

33. A laser-based cleaning system for cleaning a power generation component, comprising:
a laser positioned remotely from the power generation component for generating a laser signal;
a robotic device capable of being maneuvered into an enclosure containing the power generation component;
a laser workhead attached to the robotic device that is capable of being positioned proximate the power generation component, wherein the laser workhead can deliver a laser beam onto the power generation component surface to cause a cleaning; and
a light guide that delivers the laser signal from the laser to the laser workhead.
